(19) United States
(12) Patent Application Publication
(10) Pub. No.: US 2012/0050859 A1
(43) Pub. Date: Mar. 1, 2012

(54) POLARIZED LIGHT CONVERTING SYSTEM

(75) Inventors: Ho LU, Taoyuan (TW); Shih-po Yeh, Taoyuan (TW); Peng-fan Chen, Taoyuan (TW)

(73) Assignee: WALSIN LIHWA CORPORATION, Taoyuan (TW)

(21) Appl. No.: 12/862,804

(22) Filed: Aug. 25, 2010

(51) Int. Cl. G02B 5/30; G02B 27/28

(52) U.S. Cl. 359/485.05; 359/485.06

(57) ABSTRACT

A polarized light converting system is disclosed in the present invention. The converting system includes a polarizing splitting unit, for splitting an unpolarized incident light beam into a first polarized light beam and a second polarized light beam, passing the second polarized light beam, and reflecting the first polarized light beam; a reflector for reflecting the second polarized light beam back through the polarizing splitting unit; a condensing unit, for guiding the condensed first polarized light beam through a first area and the condensed second polarized light beam through a second area which does not overlap the first area; and a retarder unit placed at either the first area or the second area for converting the unpolarized incident light beam into polarized light beams having the same polarization state such that illumination efficiency can be increased.

### FIELD OF THE INVENTION

The present invention relates to a polarized light converting system. More particularly, the present invention relates to a polarized light converting system for splitting an unpolarized incident light beam into two polarized light beams and converting polarization state of one polarized light beam to the same polarization state as the other polarized light beam.

### BACKGROUND OF THE INVENTION

Generally, for a projector, an illumination system provides light beams so that an image can be projected out of the projector. In order to modulate the light beams with the image data, the light beams have to be polarized for a liquid crystal display (transmissive type) or a liquid crystal on silicon (reflective type) in the projector. The light beam is split into two polarized light beams. Each of the polarized light beams has electric field perpendicular to that of the other one. However, the devices mentioned above only use one polarized light beam and disregard the other one. It causes waste of energy and reduces efficiency of the projector. Therefore, polarization recycling comes out to solve the problem.

Polarization converting is used to increase the efficiency of illumination. One wasted polarized light beam is recycled and converted to the desired polarized beam. Several prior arts for polarization recycling in a projector are described below.

Please refer to FIG. 1. U.S. Pat. No. 6,064,523 discloses an apparatus for polarization conversion which has a light source for supplying vertically and horizontally linearly polarized light to an optical path and a parabolic mirror disposed in the optical path and proximate to the light source. The parabolic mirror has a mirror coating to induce a phase shift of 0°, 90°, or an arbitrary phase shift between incident light and reflected light. A polarizer, preferably a reflective polarizer film, is disposed in the optical path for reflecting light of one of the linear polarizations and for transmitting the other linear polarization. Lastly, one or more wave plates are disposed in the optical path between the polarizer and the parabolic mirror. The wave plates have opposing segments each having axes which are anti-parallel to each other for recycling the reflected linear polarization by converting it to the transmitted polarization.

'523 patent simply utilizes the reflective polarizer film and wave plates to achieve polarization recycling. Alignment of all components with high precision is not necessary so that the invention provides an easy way for assembly. However, the light source is limited to those emitting polarized light. There is another means to convert unpolarized light for the apparatus. The parabolic mirror is a must component but occupies space. The whole design is not good for compact design of a pico projector. Furthermore, according to '523 patent, the apparatus has to use collimated light beams. Other uncollimated light sources, such as a light emitting diode, are not applicable.

Another prior art is shown in FIG. 2. It shows U.S. Pat. No. 7,352,124. The invention discloses an illumination system that incorporates a light emitting diode and a partially reflecting optical element. The light emitting diode emits internally generated light beams and reflects incident light beams with high reflectivity. The partially reflecting optical element transmits a first portion of the internally generated light beams and reflects a second portion of the internally generated light beams back to the light emitting diode, where the second portion is reflected by the light emitting diode. The partially reflecting optical element can be a non-absorbing reflecting polarizer or a wavelength conversion layer. Utilizing a partially reflecting optical element and light recycling can increase the effective brightness and the output efficiency of the illumination system.

'124 patent uses a reflecting layer in the light emitting diode as a reflector to reflect light beams from the partially reflecting optical element. Meanwhile, the reflected light beams can be changed to become the first portion of the internally generated light beams and be released out of the partially reflecting optical element. It is done by a polarization mixing element between the partially reflecting optical element and the light emitting diode. By using the arrangement, the light emitting diode can emit polarized light beams and enhances lighting efficiency. Furthermore, in order to reduce light loss, the reflecting polarizer needs to be close to the light emitting diode. However, limited to the height of the light emitting diode, light loss is unavoidable.

Hence, a simple polarization converting device to provide good lighting efficiency and brightness is desired.

### SUMMARY OF THE INVENTION

This paragraph extracts and compiles some features of the present invention; other features will be disclosed in the follow-up paragraphs. It is intended to cover various modifications and similar arrangements included within the spirit and scope of the appended claims.

In accordance with an aspect of the present invention, a polarized light converting system, includes: a polarizing splitting unit, for splitting an unpolarized incident light beam into a first polarized light beam having a first polarization state and a second polarized light beam having a second polarization state which is different from the first polarization state, passing the second polarized light beam, and reflecting the first polarized light beam; a reflector for reflecting the second polarized light beam back through the polarizing splitting unit; a condensing unit, for separately condensing the reflected first and second polarized light beams, and guiding the condensed first polarized light beam through a first area and the condensed second polarized light beam through a second area which does not overlap the first area; and a retarder unit placed at the first area for converting the condensed first polarized light beam into a third polarized light beam having the second polarization state, thereby converting the unpolarized incident light beam into polarized light beams having the same polarization state such that illumination efficiency can be increased.

Preferably, the first polarization state is s-polarization state and the second polarization state is p-polarization state.

Preferably, the first polarization state is p-polarization state and the second polarization state is s-polarization state.

Preferably, the condensing unit includes a lens array having a plurality of lenses.

Preferably, the retarder unit has a shape of elongated rectangle which has a width approximately equal to half aperture of the lens of the lens array and a length approximately equal to that of the lens array.

Preferably, the retarder unit is a half-wave plate.

Preferably, the polarizing splitting unit is a polarizing beam splitter (PBS) coating layer, a polarizing beam splitter (PBS) film or a wire-grid polarizer.

Preferably, the polarized light converting system further includes a wedge prism between the polarizing splitting unit and the reflector for providing a predetermined angle between the polarizing splitting unit and the reflector.

In accordance with another aspect of the present invention, a polarized light converting system, includes: a polarizing splitting unit, for splitting an unpolarized incident light beam into a first polarized light beam having a first polarization state and a second polarized light beam having a second polarization state which is different from the first polarization state, passing the second polarized light beam, and reflecting the first polarized light beam; a reflector for reflecting the second polarized light beam back through the polarizing splitting unit; a condensing unit, for separately condensing the reflected first and second polarized light beams, and guiding the condensed first polarized light beam through a first area and the condensed second polarized light beam through a second area which does not overlap the first area; and a retarder unit placed at the second area for converting the condensed second polarized light beam into a third polarized light beam having the first polarization state, thereby converting the unpolarized incident light beam into polarized light beams having the same polarization state such that illumination efficiency can be increased.

Preferably, the first polarization state is s-polarization state and the second polarization state is p-polarization state.

Preferably, the first polarization state is p-polarization state and the second polarization state is s-polarization state.

Preferably, the condensing unit includes a lens array having a plurality of lenses.

Preferably, the retarder unit has a shape of elongated rectangle which has a width approximately equal to half aperture of the lens of the lens array and a length approximately equal to that of the lens array.

Preferably, the retarder unit is a half-wave plate.

Preferably, the polarizing splitting unit is a polarizing beam splitter (PBS) coating layer, a polarizing beam splitter (PBS) film or a wire-grid polarizer.

Preferably, the polarized light converting system further includes a wedge prism between the polarizing splitting unit and the reflector for providing a predetermined angle between the polarizing splitting unit and the reflector.

In accordance with further another aspect of the present invention, a polarized light converting system, includes: a first condensing unit, for condensing an unpolarized incident light beam; a polarizing splitting unit, for splitting the unpolarized incident light beam into a first polarized light beam having a first polarization state and a second polarized light beam having a second polarization state which is different from the first polarization state, passing the second polarized light beam, and reflecting the first polarized light beam through a first area; a reflector for reflecting the second polarized light beam back through the polarizing splitting unit and guiding the second polarized light beam through a second area which does not overlap the first area; and a retarder unit placed at the first area for converting the condensed first polarized light beam into a third polarized light beam having the second polarization state, thereby converting the unpolarized incident light beam into polarized light beams having the same polarization state such that illumination efficiency can be increased.

Preferably, the polarized light converting system further includes a collimator for collimating the unpolarized incident light beam.

Preferably, the polarized light converting system further includes a transparent plate between the polarizing splitting unit and the reflector for shifting the reflected second polarized light beam by a predetermined distance.

Preferably, the first polarization state is s-polarization state and the second polarization state is p-polarization state.

Preferably, the first polarization state is p-polarization state and the second polarization state is s-polarization state.

Preferably, the retarder unit is a half-wave plate.

Preferably, the polarizing splitting unit is a polarizing beam splitter (PBS) coating layer, a polarizing beam splitter (PBS) film or a wire-grid polarizer.

Preferably, the polarized light converting system further includes a second condensing unit placed between the polarizing splitting unit and the retarder unit, for condensing the reflected first and second polarized light beams.

Preferably, the first and second condensing units each includes a lens array having a plurality of lenses.

Preferably, the lens of the second condensing unit has an aperture approximately equals to half aperture of the lens of the first condensing unit.

Preferably, the retarder unit has a shape of elongated rectangle which has a width approximately equal to aperture of the lens of the second condensing unit and a length approximately equal to that of the second condensing unit.

In accordance with yet another aspect of the present invention, a polarized light converting system, includes: a first condensing unit, for condensing an unpolarized incident light beam; a polarizing splitting unit, for splitting the unpolarized incident light beam into a first polarized light beam having a first polarization state and a second polarized light beam having a second polarization state which is different from the first polarization state, passing the second polarized light beam, and reflecting the first polarized light beam through a first area; a reflector for reflecting the second polarized light beam back through the polarizing splitting unit and guiding the second polarized light beam through a second area which does not overlap the first area; and a retarder unit placed at the second area for converting the condensed second polarized light beam into a third polarized light beam having the first polarization state, thereby converting the unpolarized incident light beam into polarized light beams having the same polarization state such that illumination efficiency can be increased.

Preferably, the polarized light converting system further includes a collimator for collimating the unpolarized incident light beam.

Preferably, the polarized light converting system further includes a transparent plate between the polarizing splitting unit and the reflector for shifting the reflected second polarized light beam by a predetermined distance.

Preferably, the first polarization state is s-polarization state and the second polarization state is p-polarization state.

Preferably, the first polarization state is p-polarization state and the second polarization state is s-polarization state.

Preferably, the retarder unit is a half-wave plate.

Preferably, the polarizing splitting unit is a polarizing beam splitter (PBS) coating layer, a polarizing beam splitter (PBS) film or a wire-grid polarizer.

Preferably, the polarized light converting system further includes a second condensing unit placed between the polarizing splitting unit and the retarder unit, for condensing the reflected first and second polarized light beams.

Preferably, the first and second condensing units each includes a lens array having a plurality of lenses.

Preferably, the lens of the second condensing unit has an aperture approximately equals to half aperture of the lens of the first condensing unit.

Preferably, the retarder unit has a shape of elongated rectangle which has a width approximately equal to aperture of the lens of the second condensing unit and a length approximately equal to that of the second condensing unit.

### BRIEF DESCRIPTION OF THE DRAWINGS

FIG. 1 shows a polarized light converting system of a prior art.

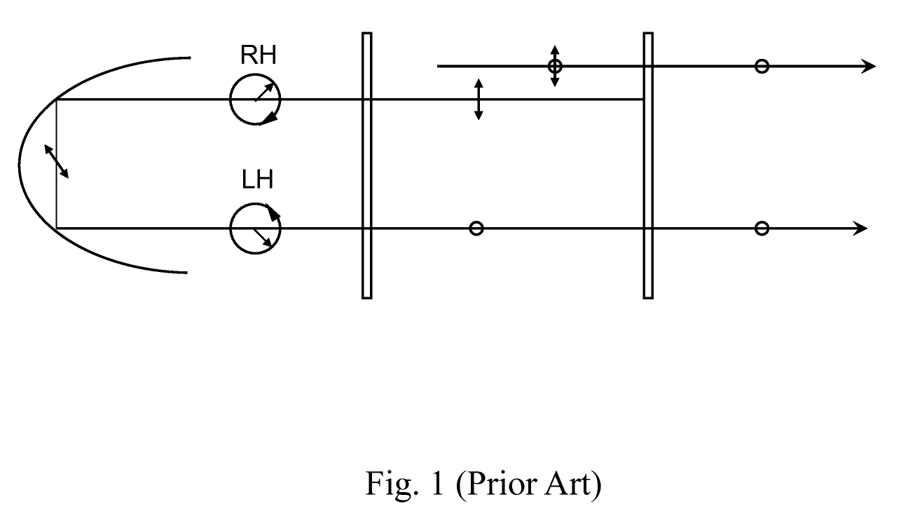

FIG. 2 shows a polarized light converting system of another prior art.

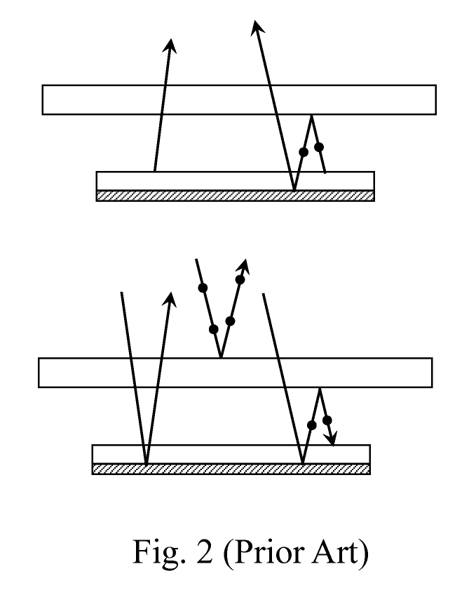

FIG. 3 illustrates a first embodiment of the present invention.

FIG. 4 illustrates a lens array and a retarder unit in FIG. 3 in a different view.

FIG. 5 illustrates a second embodiment of the present invention.

FIG. 6 illustrates a third embodiment of the present invention.

### DETAILED DESCRIPTION OF THE PREFERRED EMBODIMENTS

The present invention will now be described more specifically with reference to the following embodiments. It is to be noted that the following descriptions of preferred embodiments of this invention are presented herein for purpose of illumination and description only; it is not intended to be exhaustive or to be limited to the precise form disclosed.

In order to have good understanding of the spirit of the present invention, two embodiments are provided below with detailed description.

### First Embodiment

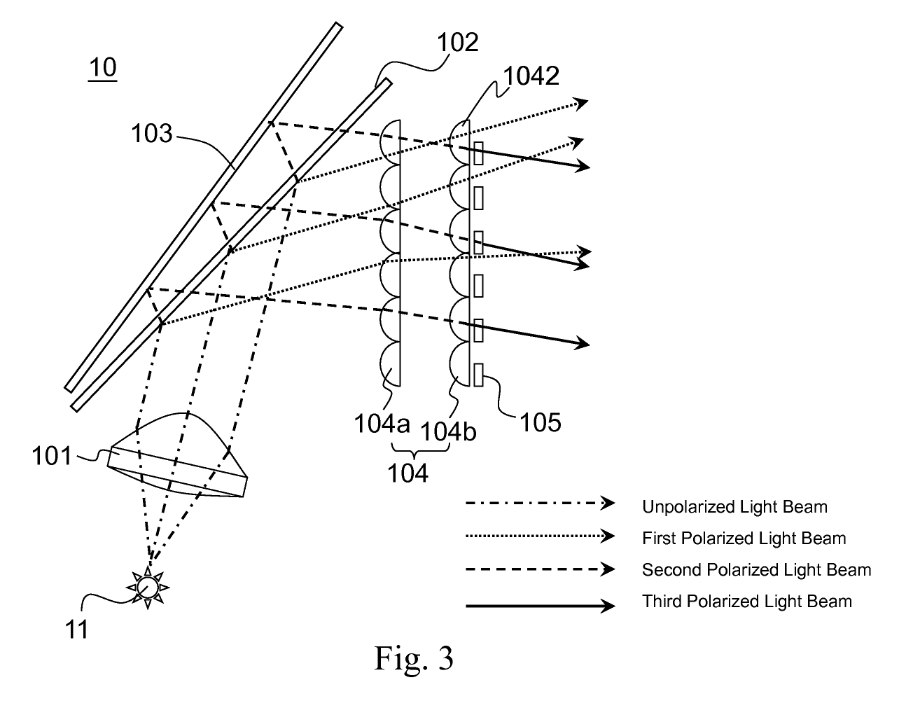

Please refer to FIG. 3. A first embodiment of the present invention is illustrated. In FIG. 3, a polarized light converting system 10 has a collimator 101, a polarizing splitting unit 102, a reflector 103, a condensing unit 104, and a retarder unit 105.

The collimator 101 is for collimating an unpolarized incident light beam from a light source 11. Any type of light source 11 can be used. In this embodiment, the light source 11 is a white light emitting diode for a compact pico projector. Alternatively, if the light source 11 is a collimated source, then the collimator 101 is not needed.

The polarizing splitting unit 102 splits the collimated unpolarized incident light beam from the collimator 101 into a first polarized light beam having a first polarization state and a second polarized light beam having a second polarization state which is different from the first polarization state. Most importantly, the polarizing splitting unit 102 can pass the second polarized light beam and reflect the first polarized light beam. In this embodiment, the first polarized light beam is a s-polarized light beam and the second polarized light beam is a p-polarized light beam. Alternatively, the first polarization state can be p-polarization state and the second polarization state can be s-polarization state.

In this embodiment, the polarizing splitting unit 102 can be a polarizing beam splitter (PBS) coating layer coated on a transparent plate, a wire-grid polarizer processed on a transparent substrate or a polarizing beam splitter (PBS) film, such as Vikuiti™ film of 3M's product, attached on a transparent plate.

The reflector 103 is formed next to the polarizing splitting unit 102. It can reflect the second polarized light beam back through the polarizing splitting unit 102. The reflector 103 can be a mirror or a plate having a reflective coating.

The condensing unit 104 separately condenses the reflected first and second polarized light beams and guides the condensed first polarized light beam through a first area and the condensed second polarized light beam through a second area which does not overlap the first area. In this embodiment, the condensing unit 104 includes two sets of lens array 104a and 104b which has a number of lenses 1042. The first and second polarized light beams are focused approximately on the surface of the lens array 104b by the lens array 104a. However, if the incident angles of the reflected first and second polarized light beams are small enough, only lens array 104a is needed. The two sets of lens array can be placed one behind the other facing the same direction or back-to-back to each other.

The retarder unit 105 can be placed either at the first area or the second area. In this embodiment, the retarder unit 105 is placed at the second area. It can convert the condensed second polarized light beam into a third polarized light beam having the first polarization state. According to the spirit of the present invention, the retarder unit 105 can optionally convert the condensed first polarized light beam into a third polarized light beam having the second polarization state while the retarder unit 105 is placed at the first area. By this way, the unpolarized incident light beam can be converted into polarized light beams having the same polarization state such that illumination efficiency can be increased.

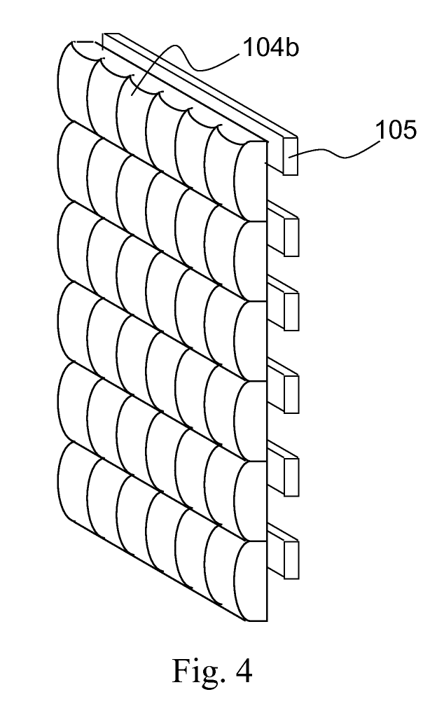

Please refer to FIG. 4. FIG. 4 illustrates the lens array 104b and the retarder unit 105 in FIG. 3 in a different view. As shown in FIG. 4, the retarder unit 105 has a shape of elongated rectangle which has a width approximately equal to half aperture of the lens 1042 of the lens array 104b and a length approximately equal to that of the lens array 104b. In the present invention, the retarder unit 105 is a half-wave plate.

Therefore, the first polarized light beam can be efficiently converted into the third polarized light beam without blocking the second polarized light beam, or the second polarized light beam can be efficiently converted into the third polarized light beam without blocking the first polarized light beam. Of course, according to the spirit of the present invention, locations of the retarder unit 105 and the condensing unit 104 can be exchanged. In this embodiment, the second polarized light beam passes the retarder unit 105 to be converted into the third polarized light beam having the first polarization state. Thus, both light beams have the same polarization state and light converting is completed.

### Second Embodiment

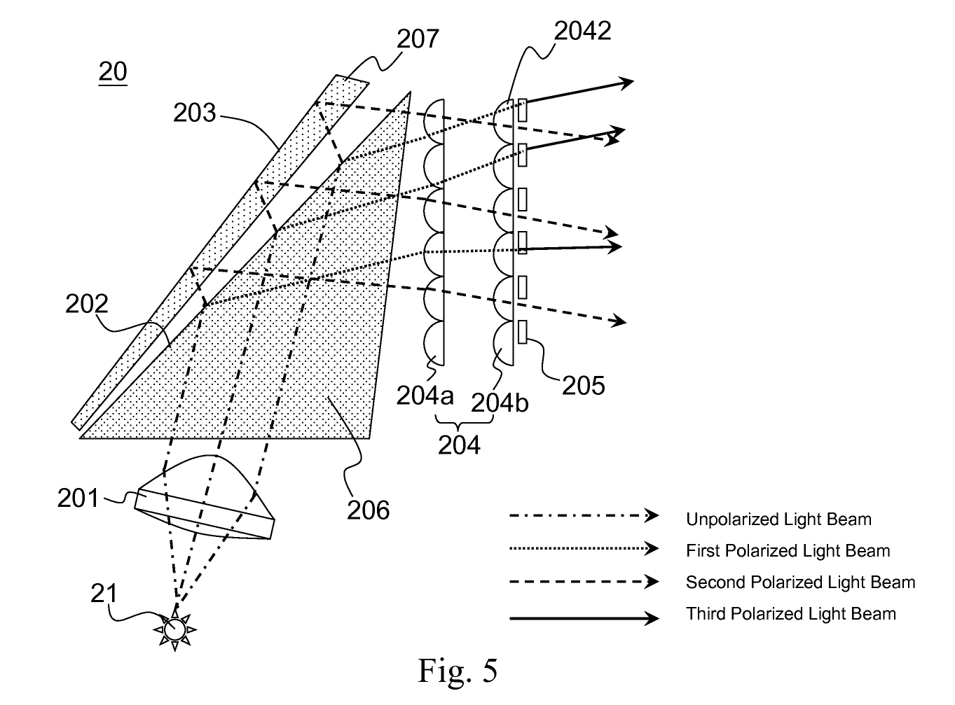

Please refer to FIG. 5. A second embodiment of the present invention is illustrated. In FIG. 5, a polarized light converting system 20 has a collimator 201, a prism 206, a wedge prism 207, a condensing unit 204, and a retarder unit 205.

The collimator 201 is for collimating an unpolarized incident light beam from a light source 21. Any type of light source 21 can be used. Same as the first embodiment, the light source 21 is a white light emitting diode for a compact pico projector. Alternatively, if the light source 21 is a collimated source, then the collimator 201 is not needed.

The prism 206 has a polarizing splitting unit 202 on one surface. The wedge prism 207 is placed next to the polarizing splitting unit 202 and has a reflector 203 formed thereon such that the wedge prism 207 is disposed between the polarizing splitting unit 202 and the reflector 203. The wedge prism 207 is for providing a predetermined angle between the polarizing splitting unit 202 and the reflector 203. The wedge prism 207 can be adhered to the polarizing splitting unit 202 or can be placed adjacent to the polarizing splitting unit 202 having a gap formed therebetween, as shown in FIG. 5.

The polarizing splitting unit 202 splits the collimated unpolarized incident light beam from the collimator 201 into a first polarized light beam having a first polarization state and a second polarized light beam having a second polarization state which is different from the first polarization state. Most importantly, the polarizing splitting unit 202 can pass the second polarized light beam and reflect the first polarized light beam. In this embodiment, the first polarized light beam is a s-polarized light beam and the second polarized light beam is a p-polarized light beam. Alternatively, the first polarization state can be p-polarization state and the second polarization state can be s-polarization state.

In this embodiment, the polarizing splitting unit 202 is a polarizing beam splitter (PBS) coating layer either coated on the prism 206 or the wedge prism 207. However, it can be replaced by a wire-grid polarizer or a polarizing beam splitter (PBS) film such as Vikuiti™ film of 3M's product.

The reflector 203 is formed on the wedge prism 207. It can reflect the second polarized light beam back through the polarizing splitting unit 202. The reflector 203 can be a mirror or a reflective coating. In this embodiment, the reflector 203 is a reflective coating.

The condensing unit 204 separately condenses the reflected first and second polarized light beams and guides the condensed first polarized light beam through a first area and the condensed second polarized light beam through a second area which does not overlap the first area. In this embodiment, the condensing unit 204 includes two sets of lens array 204a and 204b which has a number of lenses 2042. The first and second polarized light beams are focused approximately on the surface of the lens array 204b by the lens array 204a. However, if the incident angles of the reflected first and second polarized light beams are small enough, only lens array 204a is needed. The two sets of lens array can be placed one behind the other facing the same direction or back-to-back to each other.

The retarder unit 205 can be placed either at the first area or the second area. In this embodiment, the retarder unit 205 is placed at the first area. It can convert the condensed first polarized light beam into a third polarized light beam having the second polarization state. According to the spirit of the present invention, the retarder unit 205 can also optionally convert the condensed second polarized light beam into a third polarized light beam having the first polarization state while the retarder unit 205 is placed at the second area. By this way, the unpolarized incident light beam can be converted into polarized light beams having the same polarization state such that illumination efficiency can be increased.

As the first embodiment, the retarder unit 205 has a shape of elongated rectangle which has a width approximately equal to half aperture of the lens 2042 of the lens array 204b and a length approximately equal to that of the lens array 204b. In the present invention, the retarder unit 205 is a half-wave plate. Therefore, the first polarized light beam can be efficiently converted into the third polarized light beam without blocking the second polarized light beam, or the second polarized light beam can be efficiently converted into the third polarized light beam without blocking the first polarized light beam. Of course, according to the spirit of the present invention, locations of the retarder unit 205 and the condensing unit 204 can be exchanged. In this embodiment, the second polarized light beam passes the retarder unit 205 to be converted into the third polarized light beam having the first polarization state. Thus, both light beams have the same polarization state and light converting is completed.

### Third Embodiment

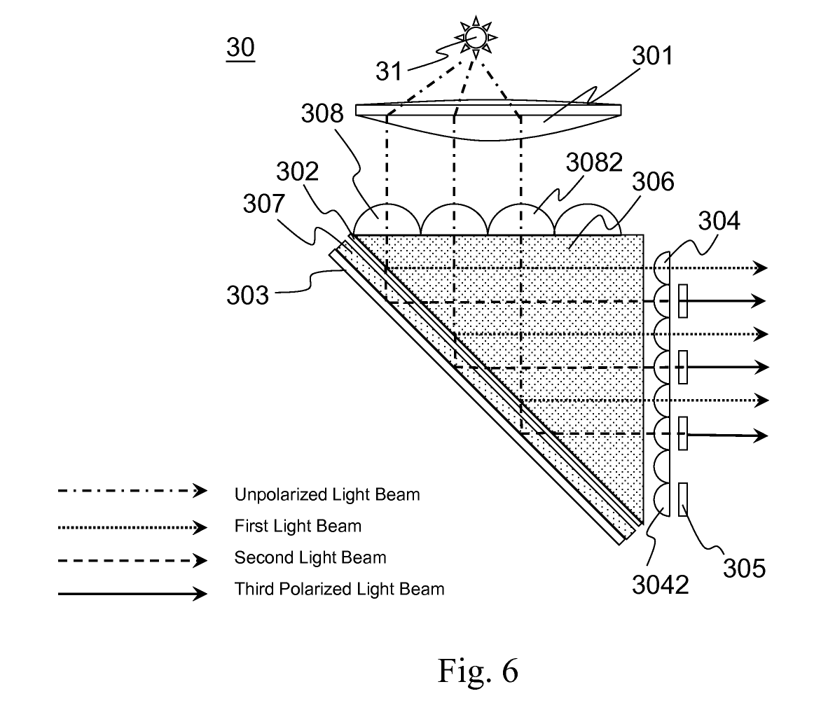

Please refer to FIG. 6. A third embodiment of the present invention is illustrated. In this embodiment, a polarized light converting system 30 has a collimator 301, a first condensing unit 308, a prism 306, a transparent plate 307, a second condensing unit 304, and a retarder unit 305, as shown in FIG. 6.

The collimator 301 is for collimating an unpolarized incident light beam from a light source 31. Any type of light source 31 can be used. As the first and second embodiments, the light source 31 is a white light emitting diode for a compact pico projector. Alternatively, if the light source 31 is a collimated source, then the collimator 301 is not needed.

The first condensing unit 308 is for condensing the unpolarized incident light beam. The prism 306 has a polarizing splitting unit 302 on one side. The transparent plate 307 is placed next to the polarizing splitting unit 302 and has a reflector 303 formed thereon such that the transparent plate 307 is disposed between the polarizing splitting unit 302 and the reflector 303. The transparent plate 307 is for shifting the reflected second polarized light beam by a predetermined distance such that the reflected first polarized light beam and the second polarized light beam can be later on separated.

The transparent plate 307 can be adhered to the polarizing splitting unit 302 or can be placed adjacent to the polarizing splitting unit 302 having a gap formed therebetween, as shown in FIG. 6.

The polarizing splitting unit 302 splits the unpolarized incident light beam from the first condensing unit 308 into a first polarized light beam having a first polarization state and a second polarized light beam having a second polarization state which is different from the first polarization state. Most importantly, the polarizing splitting unit 302 can pass the second polarized light beam and reflect the first polarized light beam through a first area. In this embodiment, the first polarized light beam is a s-polarized light beam and the second polarized light beam is a p-polarized light beam. Alternatively, the first polarization state can be p-polarization state and the second polarization state can be s-polarization state.

In this embodiment, the polarizing splitting unit 302 is a polarizing beam splitter (PBS) coating layer either coated on the prism 306 or the transparent plate 307. However, it can be replaced by a polarizing beam splitter (PBS) film such as Vikuiti™ film of 3M's product, or a wire-grid polarizer attached to the prism 306 or the transparent plate 307.

The reflector 303 is formed on the transparent plate 307. It can reflect the second polarized light beam back through the polarizing splitting unit 302 and guide the second polarized light beam through a second area which does not overlap the first area. The reflector 303 can be a mirror or a reflective coating.

The second condensing unit 304 separately condenses the reflected first and second polarized light beams. In this embodiment, the first condensing unit 308 and the second condensing unit 304 each includes a lens array which has a number of lenses 3082 and 3042.

In this embodiment, the lens 3042 of the second condensing unit 304 has an aperture approximately equals to half aperture of the lens 3082 of the first condensing unit 308, and the amount of the lenses 3082 equals or approximately equals to half of the amount of the lenses 3042.

The retarder unit 305 can be placed either at the first area or at the second area. In this embodiment, the retarder unit 305 is placed at the second area. It can convert the condensed second polarized light beam into a third polarized light beam having the first polarization state. According to the spirit of the present invention, the retarder unit 305 can optionally convert the condensed first polarized light beam into a third polarized light beam having the second polarization state while the retarder unit 305 is placed at the first area. By this way, the unpolarized incident light beam can be converted into polarized light beams having the same polarization state such that illumination efficiency can be increased.

As the first embodiment, the retarder unit 305 has a shape of elongated rectangle which has a width approximately equal to aperture of the lens 3042 of the second condensing unit 304 and a length approximately equal to that of the second condensing unit 304. As shown in FIG. 6, the retarder unit 305 is placed behind every other lens 3042. In the present invention, the retarder unit 305 is a half-wave plate. Therefore, the first polarized light beam can be efficiently converted into the third polarized light beam without blocking the second polarized light beam, or the second polarized light beam can be efficiently converted into the third polarized light beam without blocking the first polarized light beam. Of course, according to the spirit of the present invention, locations of the retarder unit 305 and the second condensing unit 304 can be exchanged. The second polarized light beam passes the retarder unit 305 to be converted into the third polarized light beam having the first polarization state. Thus, both light beams have the same polarization state and light converting is completed.

While the invention has been described in terms of what is presently considered to be the most practical and preferred embodiments, it is to be understood that the invention needs not be limited to the disclosed embodiments. On the contrary, it is intended to cover various modifications and similar arrangements included within the spirit and scope of the appended claims, which are to be accorded with the broadest interpretation so as to encompass all such modifications and similar structures.

What is claimed is:

1. A polarized light converting system, comprising:
a polarizing splitting unit, for splitting an unpolarized incident light beam into a first polarized light beam having a first polarization state and a second polarized light beam having a second polarization state which is different from the first polarization state, passing the second polarized light beam, and reflecting the first polarized light beam;
a reflector for reflecting the second polarized light beam back through the polarizing splitting unit;
a condensing unit, for separately condensing the reflected first and second polarized light beams, and guiding the condensed first polarized light beam through a first area and the condensed second polarized light beam through a second area which does not overlap the first area; and
a retarder unit placed at the first area for converting the condensed first polarized light beam into a third polarized light beam having the second polarization state, thereby converting the unpolarized incident light beam into polarized light beams having the same polarization state such that illumination efficiency can be increased.

2. The polarized light converting system according to claim 1, wherein the first polarization state is s-polarization state and the second polarization state is p-polarization state.

3. The polarized light converting system according to claim 1, wherein the first polarization state is p-polarization state and the second polarization state is s-polarization state.

4. The polarized light converting system according to claim 1, wherein the condensing unit comprises a lens array having a plurality of lenses.

5. The polarized light converting system according to claim 4, wherein the retarder unit has a shape of elongated rectangle which has a width approximately equal to half aperture of the lens of the lens array and a length approximately equal to that of the lens array.

6. The polarized light converting system according to claim 1, wherein the retarder unit is a half-wave plate.

7. The polarized light converting system according to claim 1, wherein the polarizing splitting unit is a polarizing beam splitter (PBS) coating layer, a polarizing beam splitter (PBS) film or a wire-grid polarizer.

8. The polarized light converting system according to claim 1, further comprising a wedge prism between the polarizing splitting unit and the reflector for providing a predetermined angle between the polarizing splitting unit and the reflector.

9. A polarized light converting system, comprising:
a polarizing splitting unit, for splitting an unpolarized incident light beam into a first polarized light beam having a first polarization state and a second polarized light beam having a second polarization state which is different from the first polarization state, passing the second polarized light beam, and reflecting the first polarized light beam;
a reflector for reflecting the second polarized light beam back through the polarizing splitting unit;
a condensing unit, for separately condensing the reflected first and second polarized light beams, and guiding the condensed first polarized light beam through a first area and the condensed second polarized light beam through a second area which does not overlap the first area; and
a retarder unit placed at the second area for converting the condensed second polarized light beam into a third polarized light beam having the first polarization state, thereby converting the unpolarized incident light beam into polarized light beams having the same polarization state such that illumination efficiency can be increased.

10. The polarized light converting system according to claim 9, wherein the first polarization state is s-polarization state and the second polarization state is p-polarization state.

11. The polarized light converting system according to claim 9, wherein the first polarization state is p-polarization state and the second polarization state is s-polarization state.

12. The polarized light converting system according to claim 9, wherein the condensing unit comprises a lens array having a plurality of lenses.

13. The polarized light converting system according to claim 12, wherein the retarder unit has a shape of elongated rectangle which has a width approximately equal to half aperture of the lens of the lens array and a length approximately equal to that of the lens array.

14. The polarized light converting system according to claim 9, wherein the retarder unit is a half-wave plate.

15. The polarized light converting system according to claim 9, wherein the polarizing splitting unit is a polarizing beam splitter (PBS) coating layer, a polarizing beam splitter (PBS) film or a wire-grid polarizer.

16. The polarized light converting system according to claim 9, further comprising a wedge prism between the polarizing splitting unit and the reflector for providing a predetermined angle between the polarizing splitting unit and the reflector.

17. A polarized light converting system, comprising:
a first condensing unit, for condensing an unpolarized incident light beam;
a polarizing splitting unit, for splitting the unpolarized incident light beam into a first polarized light beam having a first polarization state and a second polarized light beam having a second polarization state which is different from the first polarization state, passing the second polarized light beam, and reflecting the first polarized light beam through a first area;
a reflector for reflecting the second polarized light beam back through the polarizing splitting unit and guiding the second polarized light beam through a second area which does not overlap the first area; and
a retarder unit placed at the first area for converting the condensed first polarized light beam into a third polarized light beam having the second polarization state, thereby converting the unpolarized incident light beam into polarized light beams having the same polarization state such that illumination efficiency can be increased.

18. The polarized light converting system according to claim 17, further comprising a collimator for collimating the unpolarized incident light beam.

19. The polarized light converting system according to claim 17, further comprising a transparent plate between the polarizing splitting unit and the reflector for shifting the reflected second polarized light beam by a predetermined distance.

20. The polarized light converting system according to claim 17, wherein the first polarization state is s-polarization state and the second polarization state is p-polarization state.

21. The polarized light converting system according to claim 17, wherein the first polarization state is p-polarization state and the second polarization state is s-polarization state.

22. The polarized light converting system according to claim 17, wherein the retarder unit is a half-wave plate.

23. The polarized light converting system according to claim 17, wherein the polarizing splitting unit is a polarizing beam splitter (PBS) coating layer, a polarizing beam splitter (PBS) film or a wire-grid polarizer.

24. The polarized light converting system according to claim 17, further comprising a second condensing unit placed between the polarizing splitting unit and the retarder unit, for condensing the reflected first and second polarized light beams.

25. The polarized light converting system according to claim 24, wherein the first and second condensing units each comprises a lens array having a plurality of lenses.

26. The polarized light converting system according to claim 25, wherein the lens of the second condensing unit has an aperture approximately equals to half aperture of the lens of the first condensing unit.

27. The polarized light converting system according to claim 25, wherein the retarder unit has a shape of elongated rectangle which has a width approximately equal to aperture of the lens of the second condensing unit and a length approximately equal to that of the second condensing unit.

28. A polarized light converting system, comprising:
a first condensing unit, for condensing an unpolarized incident light beam;
a polarizing splitting unit, for splitting the unpolarized incident light beam into a first polarized light beam having a first polarization state and a second polarized light beam having a second polarization state which is different from the first polarization state, passing the second polarized light beam, and reflecting the first polarized light beam through a first area;
a reflector for reflecting the second polarized light beam back through the polarizing splitting unit and guiding the second polarized light beam through a second area which does not overlap the first area; and
a retarder unit placed at the second area for converting the condensed second polarized light beam into a third polarized light beam having the first polarization state, thereby converting the unpolarized incident light beam into polarized light beams having the same polarization state such that illumination efficiency can be increased.

29. The polarized light converting system according to claim 28, further comprising a collimator for collimating the unpolarized incident light beam.

30. The polarized light converting system according to claim 28, further comprising a transparent plate between the polarizing splitting unit and the reflector for shifting the reflected second polarized light beam by a predetermined distance.

31. The polarized light converting system according to claim 28, wherein the first polarization state is s-polarization state and the second polarization state is p-polarization state.

32. The polarized light converting system according to claim 28, wherein the first polarization state is p-polarization state and the second polarization state is s-polarization state.

33. The polarized light converting system according to claim 28, wherein the retarder unit is a half-wave plate.

34. The polarized light converting system according to claim 28, wherein the polarizing splitting unit is a polarizing beam splitter (PBS) coating layer, a polarizing beam splitter (PBS) film or a wire-grid polarizer.

35. The polarized light converting system according to claim 28, further comprising a second condensing unit placed between the polarizing splitting unit and the retarder unit, for condensing the reflected first and second polarized light beams.

36. The polarized light converting system according to claim 35, wherein the first and second condensing units each comprises a lens array having a plurality of lenses.

37. The polarized light converting system according to claim 36, wherein the lens of the second condensing unit has an aperture approximately equals to half aperture of the lens of the first condensing unit.

38. The polarized light converting system according to claim 36, wherein the retarder unit has a shape of elongated rectangle which has a width approximately equal to aperture of the lens of the second condensing unit and a length approximately equal to that of the second condensing unit.
